(19) United States
(12) Patent Application Publication
(10) Pub. No.: US 2014/0157943 A1
(43) Pub. Date: Jun. 12, 2014

(54) ROTATABLE AND STATIONARY GATES FOR MOVEMENT CONTROL

(71) Applicant: BENHAM John, Camarillo, CA (US)

(72) Inventor: BENHAM John, Camarillo, CA (US)

(73) Assignee: Kavlico Corporation, Moorpark, CA (US)

(21) Appl. No.: 13/707,791

(22) Filed: Dec. 7, 2012

(51) Int. Cl. G05G 5/06

(52) U.S. Cl. CPC G05G 5/06
USPC 74/526; 74/527

(57) ABSTRACT

Disclosed are assemblies, systems, devices, methods, and other implementations, including an assembly that includes a moveable mechanical structure (e.g., a lever), and a gate to control movement of the moveable mechanical structure. The gate include a rotatable body, and at least two appendages extending from the rotatable body, including a first appendage configured to stop rotational movement of the gate in a first direction beyond a first angular position when the first appendage contacts a blocking structure, and a second appendage configured to contact the moveable mechanical structure that, when the moveable mechanical structure contacts the second appendage, actuates the gate to cause rotation of the gate.

### BACKGROUND

Conventional controls, such as controls used in aircraft to control, for example, deployment of flaps, engine thrust, landing gear deployment, brake system activation, etc., include control slide guide arrangements with depressions (or other type of structural features, such as slots, to hold a control structure in place) defining positions into which the control structure could be moved. Such arrangements are susceptible to accidental movement of a moveable structure, such as a lever, into positions that the user (e.g., pilot) did not intend.

For example, a user may accidently move a lever into an unintended position in the assembly (e.g., one of the plurality of depressions) corresponding to an operation that is initiated when the lever is moved to that position. For instance, an accidental movement of a flaps control lever into a position corresponding to full deployment of the flaps while the aircraft is traveling at a high speed and at high altitude could result in significant turbulence to the aircraft.

### SUMMARY

Disclosed are assemblies, systems, devices, methods, and other implementations of using one or more rotatable gates and/or fixed (stationary) gates to control the movement of a moveable mechanical structure such as a lever.

The implementations described herein include assemblies with a specified gate pattern to control the movement of, for example, a cockpit control lever for an aircraft. When the movement of a cockpit control lever needs to be restricted to steps in any direction, a series of stationary gates and bulks may be combined with, for example, rotatable gates. In order to move the lever, a collar or trigger may be raised or lowered by an operator to allow cross-pins, for example, to pass the gates or bulks. Steps or increments may be controlled by alternating the placement of the gates (slidable and/or rotatable, as well as stationary gates) and numbers of cross pins. Special combinations of motion may be established to restrict the “jumps” between the gates, thus producing a unique control.

Accordingly, in some variations, a gate to control movement of mechanical structures is disclosed. The gate includes a rotatable body, and at least two appendages extending from the rotatable body, including a first appendage configured to stop rotational movement of the gate in a first direction beyond a first angular position when the first appendage contacts a blocking structure, and a second appendage configured to contact a moveable mechanical structure external to the gate that, when the moveable mechanical structure contacts the second appendage, actuates the gate to cause rotation of the gate.

Embodiments of the gate may include at least some of the features described in the present disclosure, including one or more of the following features.

The gate may further include one or more springs configured to stop rotational movement of the gate in a second direction beyond a second angular position when the one or more springs contact at least one blocking structure, the one or more springs being biased to cause the rotatable body to return to a resting angular position when the gate is not actuated.

The rotatable body may include a disc.

In some variations, an assembly is disclosed. The assembly includes a moveable mechanical structure, and a gate to control movement of the moveable mechanical structure. The gate include a rotatable body, and at least two appendages extending from the rotatable body, including a first appendage configured to stop rotational movement of the gate in a first direction beyond a first angular position when the first appendage contacts a blocking structure, and a second appendage configured to contact the moveable mechanical structure that, when the moveable mechanical structure contacts the second appendage, actuates the gate to cause rotation of the gate.

Embodiments of the assembly may include at least some of the features described in the present disclosure, including at least some of the features described above in relation to the gate, as well as one or more of the following features.

The moveable mechanical structure may include a lever configured to be moved along a pre-determined path. The lever may be a lever to control flap extension in an aircraft.

The blocking structure may include an archway including a slot defining the pre-determined path in which the lever is configured to be moved.

The assembly may further include one or more stationary gates, with each of the one or more stationary gates including at least one of, for example, a member defining a depression that is configured to prevent movement of the moveable mechanical structure when a cross-pin extending transversely from the moveable mechanical structure is lowered into the depression, and/or a bulk protrusion extending from an elevated supporting structure that is configured to prevent movement of the moveable mechanical structure when the cross-pin contacts the bulk protrusion.

The moveable mechanical structure may further include another cross-pin extending transversely from the moveable mechanical structure, the other cross-pin configured to actuate the second appendage of the rotatable gate when the other cross-pin contacts the rotatable gate.

The assembly may further include one or more additional gates to control movement of the moveable mechanical structure, each of the one or more additional gates including a corresponding rotatable body, and corresponding at least two appendages extending from the corresponding rotatable body, including a corresponding first appendage configured to stop rotational movement of the corresponding each of the one or more additional gates in a corresponding first direction beyond a corresponding first angular position when the first corresponding appendage contacts a corresponding blocking structure, and a corresponding second appendage configured to contact the moveable mechanical structure that, when the moveable mechanical structure contacts the corresponding second appendage, actuates the corresponding each of the one or more additional gates to cause rotation of the corresponding each of the one or more additional gates.

The rotatable gate may define a pre-determined sequence of actuation operations required to be applied to the moveable mechanical structure to move the mechanical structure from a first position to a second position. The pre-determined sequence of operations may include one or more of, for example, an operation to push the moveable mechanical structure, an operation to pull a cross-pin of the moveable mechanical structure, and/or an operation to release the cross-pin of the moveable mechanical structure.

In some variations, another assembly is disclosed. The assembly includes a moveable mechanical structure, and one or more rotatable gates to control movement of the moveable mechanical structure, with each of the one or more rotatable gates including a rotatable body, and an appendage extending from the rotatable body, the appendage configured to contact the moveable mechanical structure that, when the moveable mechanical structure contacts the appendage, actuates the gate to cause rotation of the gate. The assembly further includes one or more stationary gates, with each of the one or more stationary gates including one or more of, for example, a member defining a depression that is configured to prevent movement of the moveable mechanical structure when a cross-pin extending transversely from the moveable mechanical structure is lowered into the depression, and/or a bulk protrusion extending from an elevated supporting structure that is configured to prevent movement of the moveable mechanical structure when the cross-pin contacts the bulk protrusion.

Embodiments of the assembly may include at least some of the features described in the present disclosure, including at least some of the features described above in relation to the gate and the first assembly, as well as one or more of the following features.

The assembly may further include one or more springs coupled to the rotatable body of at least one of one or more rotatable gates, the one or more springs biased to cause the rotatable body of the at least one of the one or more rotatable gates to return to a resting angular position when the at least one of the one or more rotatable gates is not actuated.

The one or more rotatable gates and the one or more stationary gates may define a pre-determined sequence of actuation operations required to be applied to the moveable mechanical structure to move the mechanical structure from a first position to a second position.

Unless defined otherwise, all technical and scientific terms used herein have the same meaning as commonly or conventionally understood. As used herein, the articles “a” and “an” refer to one or to more than one (i.e., to at least one) of the grammatical object of the article. By way of example, “an element” means one element or more than one element. “About” and/or “approximately” as used herein when referring to a measurable value such as an amount, a temporal duration, and the like, is meant to encompass variations of ±20% or ±10%, ±5%, or +0.1% from the specified value, as such variations are appropriate to in the context of the systems, devices, circuits, methods, and other implementations described herein. “Substantially” as used herein when referring to a measurable value such as an amount, a temporal duration, a physical attribute (such as frequency), and the like, is also meant to encompass variations of ±20% or ±10%, ±5%, or +0.1% from the specified value, as such variations are appropriate to in the context of the systems, devices, circuits, methods, and other implementations described herein.

As used herein, including in the claims, “or” and “and” as used in a list of items prefaced by “at least one of” or “one or more of” indicates that any combination of the listed items may be used. For example, a list of “at least one of A, B, or C” includes any of the combinations A or B or C or AB or AC or BC and/or ABC (i.e., A and B and C). Furthermore, to the extent more than one occurrence or use of the items A, B, or C is possible, multiple uses of A, B, and/or C may form part of the contemplated combinations. For example, a list of “at least one of A, B, or C” may also include AA, AAB, AAA, BB, etc.

As used herein, including in the claims, unless otherwise stated, a statement that a function, operation, or feature, is “based on” an item and/or condition means that the function, operation, function is based on the stated item and/or condition and may be based on one or more items and/or conditions in addition to the stated item and/or condition.

Unless defined otherwise, all technical and scientific terms used herein have the same meaning as commonly understood by one of ordinary skill in the art to which this disclosure pertains.

Details of one or more implementations are set forth in the accompanying drawings and in the description below. Further features, aspects, and advantages will become apparent from the description, the drawings, and the claims.

### BRIEF DESCRIPTION OF THE FIGURES

FIG. 1 is a side-view diagram of an interior of an assembly that includes a rotatable gate.

FIG. 2 is a perspective diagram of an assembly with a rotatable gate.

FIGS. 3-10 are side-view diagrams of the assembly of FIG. 1 showing operation of the rotatable gate and resultant movements of the various parts of the assembly caused through interaction of a lever with the rotatable gate and with other parts of the assembly.

FIG. 11A is a side-view diagram of a rotatable gate with one appendage and of an interior of assembly that includes the rotatable gate with one appendage.

FIGS. 11B-D are side-view diagrams of the interior of the assembly of FIG. 11A, showing the rotatable gate of FIG. 11A in operation in the assembly.

FIG. 12 is a side view diagram of an interior of an example assembly that includes a bulk gate.

FIGS. 13-19 are side-view diagrams of the interior of the assembly of FIG. 12, showing operation of the bulk gate and resultant movements of the various parts of the assembly caused through interaction of a lever with the bulk gate and with other parts of the assembly.

Like reference symbols in the various drawings indicate like elements.

### DETAILED DESCRIPTION

Disclosed herein are assemblies, systems, devices, methods, and other implementations, including a gate to control movement of mechanical structures, e.g., levers controlling apparatus, where error tolerance is low, for example, when actuating levers of airplane controls (e.g., for flap deployment, brake controls, landing gear control, etc.) The gate includes a rotatable body (such as, for example, a disc), and at least two appendages (projections) extending from the rotatable body, including a first appendage configured to stop rotational movement of the gate in a first direction beyond a first angular position when the first appendage contacts a blocking structure, and a second appendage configured to contact a moveable mechanical structure external to the gate that, when the moveable mechanical structure contacts the second appendage, actuates the gate to cause rotation of the gate.

In some embodiments, assemblies that incorporate rotatable gates, such as those described herein, may be used to implement pre-determined sequences of actuation operations of a mechanical structure (e.g., pushing, pulling, releasing) that a user would have to perform on the mechanical structure in order to move the mechanical structure from a first position to a second position. This pre-determined sequence of operations (effectively defining a pre-determined path to be taken by the moveable mechanical structure) can reduce the likelihood of an unintended or accidental movement of the mechanical structure in a way that could result in serious consequences. For example, assemblies that include rotatable gates may be used to implement lever controls to deploy landing gears, flaps, and/or other critical systems of an aircraft, to thus prevent accidental deployment of those systems which could result in damage to the aircraft and/or could severely compromise the safety of the pilots and other passengers. The assemblies described herein may be used to control other types of apparatus (e.g., other vehicles or machines) and/or in other types of applications.

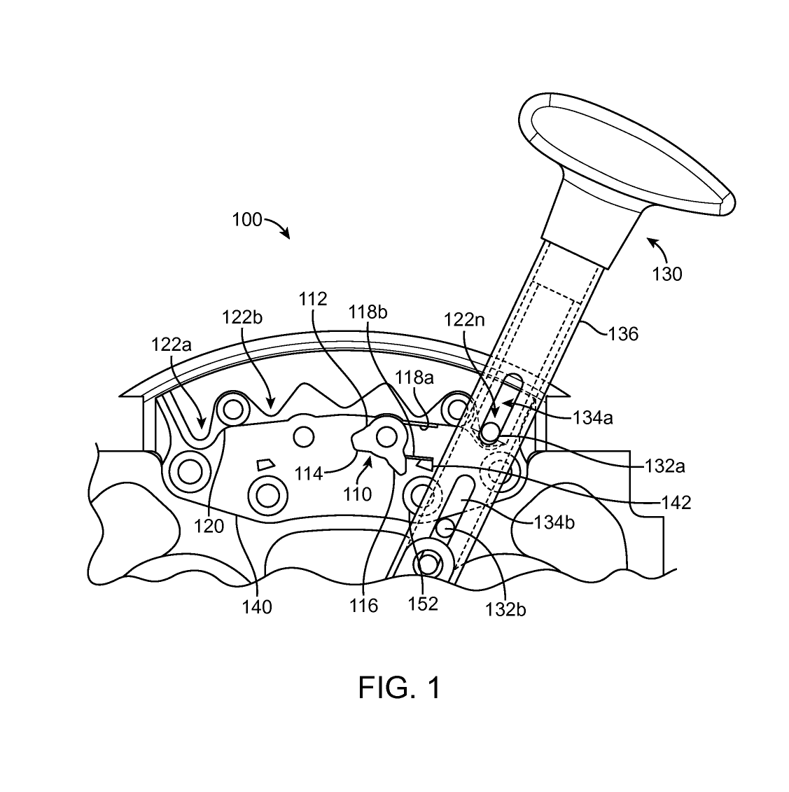

With reference to FIG. 1, a side-view diagram of an interior of an assembly 100 that includes a rotatable gate 110 is shown. In some implementations, the gate 110 may include a rotatable body, such as a disc 112, and at least two projections, also referred to as appendages, extending from the rotatable body. A first appendage 114 is configured to stop rotational movement of the gate 110 in a first direction, for example, in a clockwise direction, beyond a first angular position of the rotatable body when the first appendage 114 contacts a blocking structure, such as a frame 120 (also referred to as an archway) that include depressions 122a-n that define operational positions of a moveable mechanical structure 130, such as a lever, whose movement is controlled/manipulated through the use of such devices as the rotatable gate 110. A second appendage 116 extending from the disc 112, at another location along the surface of the disc 112, is configured to interact with the moveable mechanical structure 130. When the mechanical structure contacts the second appendage 116, it pushes the appendage, thus actuating the gate 110 to cause its rotation. In the example of FIG. 1, contact by the mechanical structure (lever) 130 causes rotation of the gate 110 in a clockwise direction.

The gate 110 also includes one or more resilient members, such as springs 118a and 118b, which are configured to stop rotational movement of the gate in a second direction (e.g., counter-clockwise direction) beyond a second angular position of the rotatable gate 110 when the one or more springs contact the blocking structure 120. The one or more resilient members 118a and 118 b are biased in such a way so as to cause the rotatable body of the gate 110 to return to a resting angular position when the gate is not actuated.

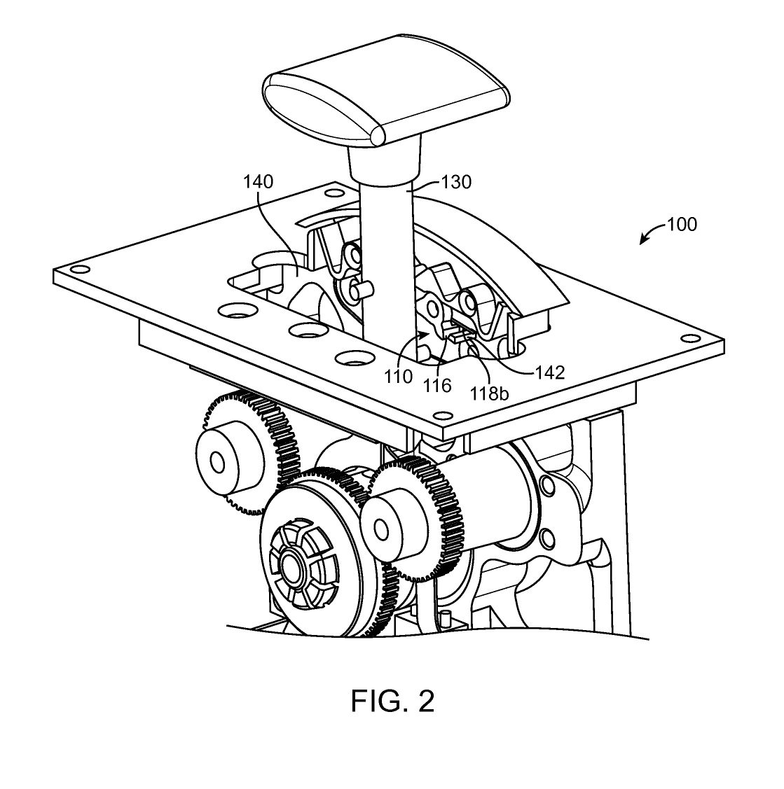

For example, the two springs 118a and 118b are each coupled to the disc 112 of the gate 110 at two locations. When not actuated, the gate 110 is in its resting position in which, in the example of FIG. 1, the spring 118b is placed, and is resting, on a protrusion 142. The protrusion 142 extends perpendicularly to a plane of a supporting plate 140. FIG. 2, providing a perspective diagram of the assembly 100 of FIG. 1, shows the rotatable gate 110 coupled to the supporting plate 140, with the spring 118b of the rotatable gate 110 resting on the protrusion 142. The protrusion 142 is configured to block, and thus to prevent or inhibit, the spring 118b from moving beyond the protrusion 142 when the rotatable gate is rotating in the first direction (i.e., when actuated by the mechanical structure 130). As the rotatable gate rotates in the first direction (i.e., clockwise direction, in the example embodiments of FIGS. 1 and 2), the spring 118b, pushed against the protrusion 142, will be extended.

The first spring 118a is coupled to the disc 112. When the rotatable gate is rotated in the second direction (i.e., counter-clockwise direction) and is pushed against the bottom surface of the frame 120, the spring 118a becomes compressed or otherwise twisted. When actuation of the rotatable gate to cause counter-clockwise rotation ceases, the compressed/twisted spring exerts a force in the opposite direction (i.e., in a clockwise direction in this example) to cause the rotatable gate to rotate in the clockwise direction.

Operation of the rotatable gate 110, and, more generally, of the assembly 100, will now be described with reference to FIGS. 1 and 3-10, each showing the resultant movements of the various parts of the assembly caused through interaction of the mechanical structure 130 (the lever) with the rotatable gate 110 and with other parts of the assembly 100. In FIG. 1, the mechanical structure 130 is depicted as being in an initial position, which may correspond to a position that results, or resulted, in the flaps of the wings of an aircraft being fully deployed. The mechanical structure 130, whose movement is being regulated, in part, by the assembly 100, may be used in other applications to control various other systems (e.g., to control factory machinery, to control other types of moving systems, etc.) In its initial position, movement of the mechanical structure 130 in a direction substantially along the length of the assembly 100 or the frame 120 is prevented/inhibited using, for example, cross-pins 132a and 132b that extend through slots 134a and 134b, respectively, of a shaft 136 of the mechanical structure 130. In the initial position of the mechanical structure 130, the center portions of the cross pins 132a and 132b are resting at the bottom ends of the slots 134a and 134b. At least one end of the top cross pin 132a is resting at the bottom of the depression 122n defined in the frame 120. The depressions 122a-n (shaped, in some embodiments, as the troughs of a wave) are also referred to as fixed gates. The bottom cross pin 132b, on the other hand, is resting underneath the supporting plate 140, below a structure 152. The depression 122a and the structure 152 both prevent/inhibit movement of the cross pins in a direction that runs along the length of the frame 120 or the supporting plate 140, and thus prevent/inhibit movement of the mechanical structure 130 in a direction along the length of the frame 120 or the supporting plate 140.

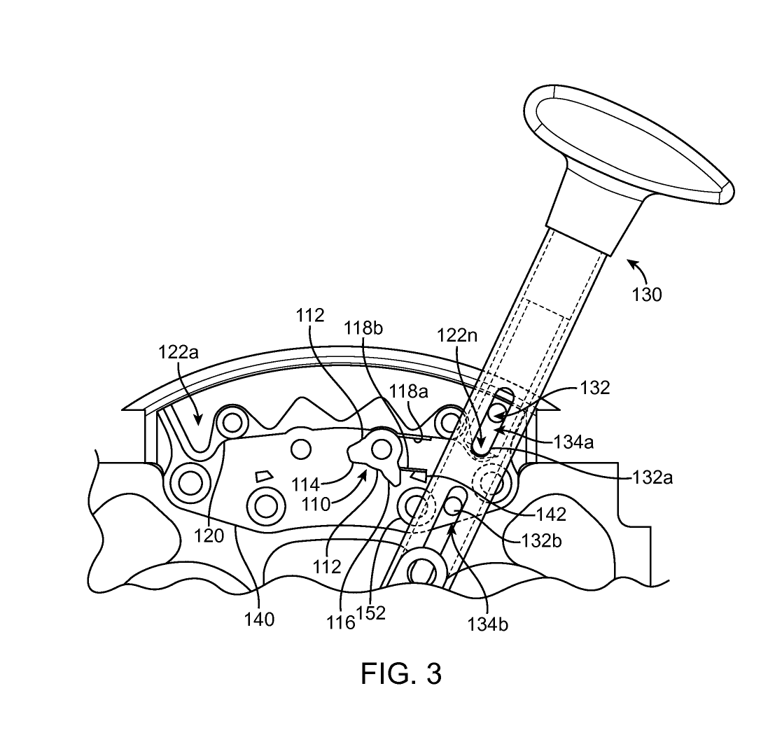

As depicted in FIG. 3, to enable movement of the example mechanical structure 130, the cross pins 132a and 132b are displaced towards the other end (top/upper ends in FIG. 3) of the slots 134a and 134b. Displacement of the cross-pins 132a and 132b may be performed by, for example, manually pulling the cross pins in an upwards direction, lifting some other handle or actuating device to cause a cord or a spring coupled to the cross pins to be pulled, etc. Moving the cross pin 132a towards the other end of the slot 134a causes the cross pin 132a to be lifted outside of the depression 122n. Moving the cross pin 132b towards the other end of the slot 134b enables the cross pin 132b to be moved along or over the structure 152, to thus clear that blocking structure and enable the mechanical structure 130 to be moved from its position substantially above the depression 122n towards the depression 122a at the other end of the frame 120.

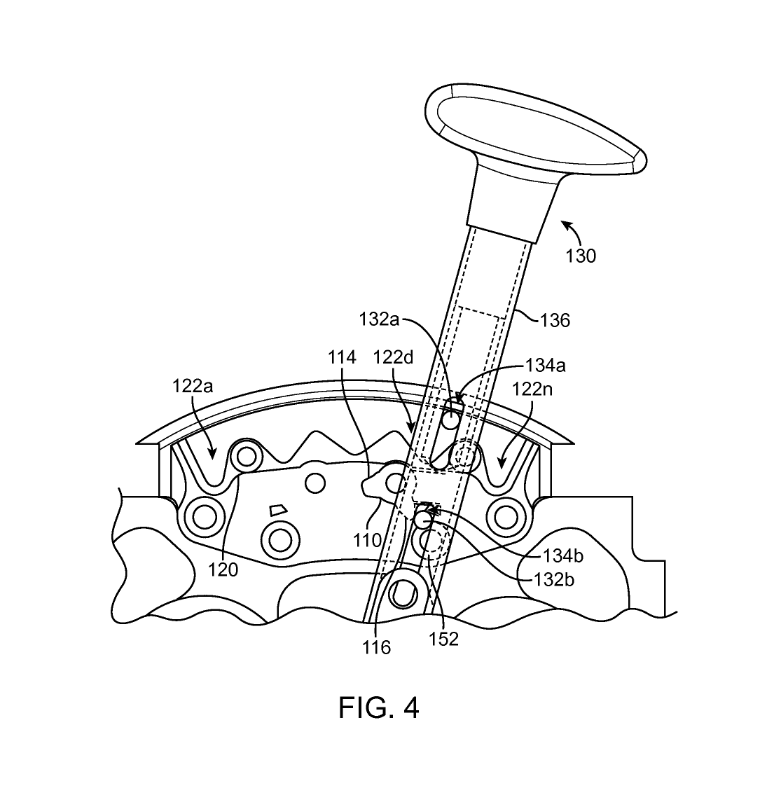

FIG. 4 depicts the assembly 100 with the mechanical structure having been moved from its initial resting position towards the depression adjacent to the depression 122n (the adjacent depression is marked as the depression 122d). As shown, the mechanical structure (the lever) 130 may be configured so that while the lever is moving in a direction along the length of the frame 120, the cross pins 132a and 132b need to be in their pulled (lifted) positions, e.g., near the top end of the slots 134a and 134b. Such an implementation can reduce the likelihood of an unintended movement of the lever 130. However, such a movement control mechanism cannot prevent a situation where the user accidently moves the lever too far and into an unintended gate (such as any of the fixed gate depressions 122a-n). Thus, in some implementations, a rotatable gate, such as the gate 110, may be included in the assembly 100 to provide a movement control mechanism that would require the user to, in order to move the lever along the length of frame 120 or of the supporting plate 140, to first release the cross pins (or some other latch mechanism), to thus cause the cross pins to be lowered, before lifting the cross pins again to be able to continue with movement of the lever along the length of the frame 120.

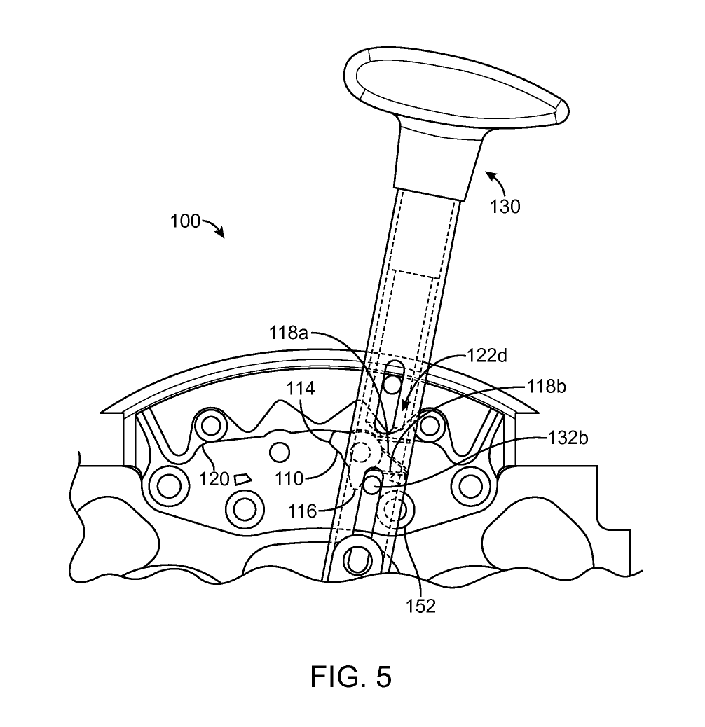

Particularly, as shown in FIG. 4, as the bottom cross pin 134b passes over or along the structure 152, the cross pin 134b of the mechanical structure 130 will hit/contact the second appendage 116 of the rotatable gate 110, which, prior to being contacted by the cross pin 134b, was in its resting position. As illustrated in FIG. 5, as the cross pin 132b continues to move along the length of the frame 120 as a result of the movement of the lever 130 by the user, the cross pin 132b mechanically actuates the appendage 116 and causes it and the rotatable gate 110 to rotate in a clockwise direction. The appendage 116, and thus the rotatable gate 110 and the first appendage 114, will continue to rotate in a clockwise direction until the first appendage 114 reaches and contacts the frame 120. The frame 120 is configured to block further rotation of the appendage 114, and thus it blocks further rotation of the rotatable gate 110. Because the rotatable gate can no longer rotate once the appendage 114 strikes the frame 120 (or when the appendage 114 hits some other blocking structure), the cross pin 132b, and thus the lever 130, cannot proceed in their movement along the length of the frame 120 and/or the supporting plate 140.

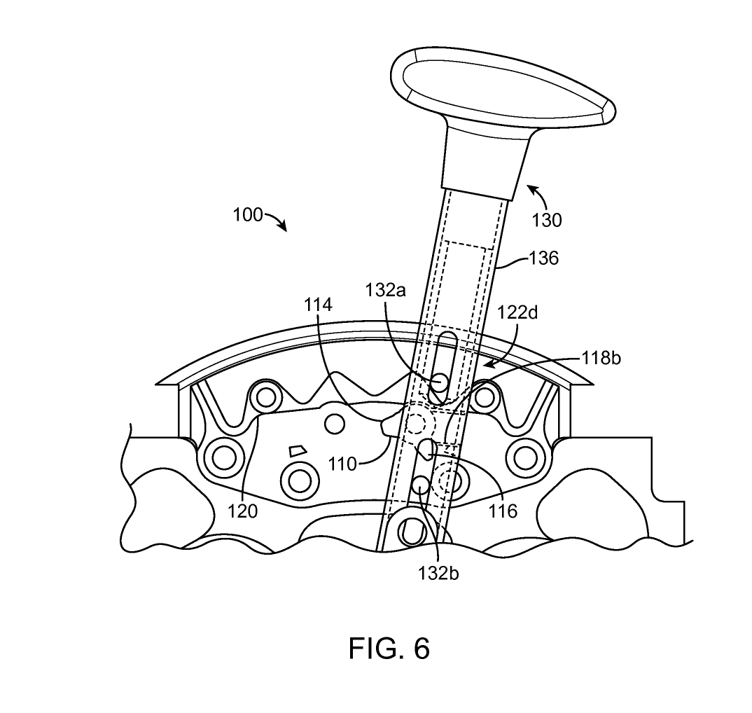

To enable the mechanical structure (lever) 130 to continue moving along the frame 120 and/or the supporting plate 140, the cross pin 132b needs to clear the rotatable gate. Accordingly, with reference to FIG. 6, the cross pins 132a and 132a are released, or otherwise are caused to move towards the bottom ends of their respective slots. For example, the user may simply release his/her grip on the cross pins to cause the cross pins 132a and 132b to move to the bottom ends of their respective slots through, for example, a biasing force of springs (not shown) that may couple the cross pins to the shaft 136 of the lever.

As the cross pin 132b is displaced towards the bottom end of the slot 134b it breaks contact with the second appendage 116 of the rotatable gate 110. Because the appendage 116 is no longer actuated by the cross pin 132b, the appendage 116, and with it the rest of the rotatable gate 110, return to the gate's resting position (e.g., as a result of biasing force exerted by the spring 118b that causes the rotatable gate to rotate in a counter-clockwise direction). The rotatable gate thus returns to its resting position when the cross pins are caused to be lowered towards the bottom ends of their respective slots 134a and 134b. In that position, the cross pin 132a has been lowered into the depression 122d which is located approximately above the rotatable gate 110.

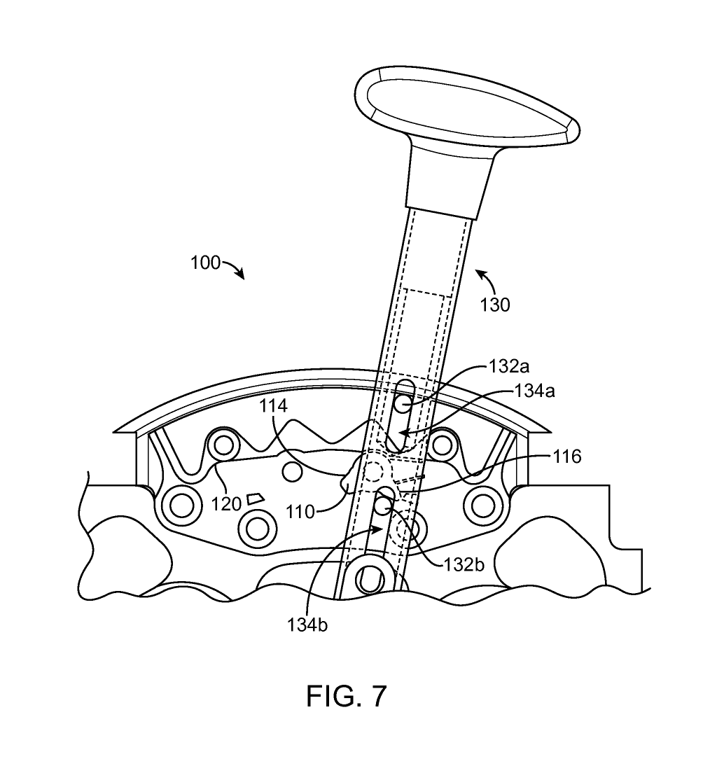

With the rotatable gate 110 having returned to its resting position, and the cross-pins 132a and 132b lowered to the bottom ends of their respective slots, to continue moving the lever 130 to its destination position (assuming the destination position is elsewhere than at the depression 122d), the cross-pins 132a and 134b need to be lifted again. Thus, with reference to FIG. 7, the cross pins 132a and 132b are actuated to displace them towards the upper ends of their respective slots 134a and 134b, e.g., by having the user lift the cross pins, lifting a handle that pulls a cord coupled to the cross pins, or otherwise actuating the cross pins. With the cross pin 132a in its lifted position, the cross bin is positioned out of the depression 122d, and therefore the movement of the lever 130 is not hindered/inhibited by the depression 122d. As further depicted in FIG. 7, when the cross pin 132b is actuated to its lifted position, it comes in contact with the other side of the appendage 116 (i.e., the side that was not actuated by the cross pin 132b when the lever 130 was moving from its position in the depression 122n to its position in the depression 122d). Because the rotatable gate 110 is, at that point, in its resting position with the appendage 114 not pushed against the frame 120 (as it was when the cross-pin 132b was actuating the first side of the appendage 116 in the manner shown, for example, in FIG. 5), the cross pin 132b can be moved in a direction along the length of the frame 120 without the rotatable gate 110 inhibiting or hindering its movement.

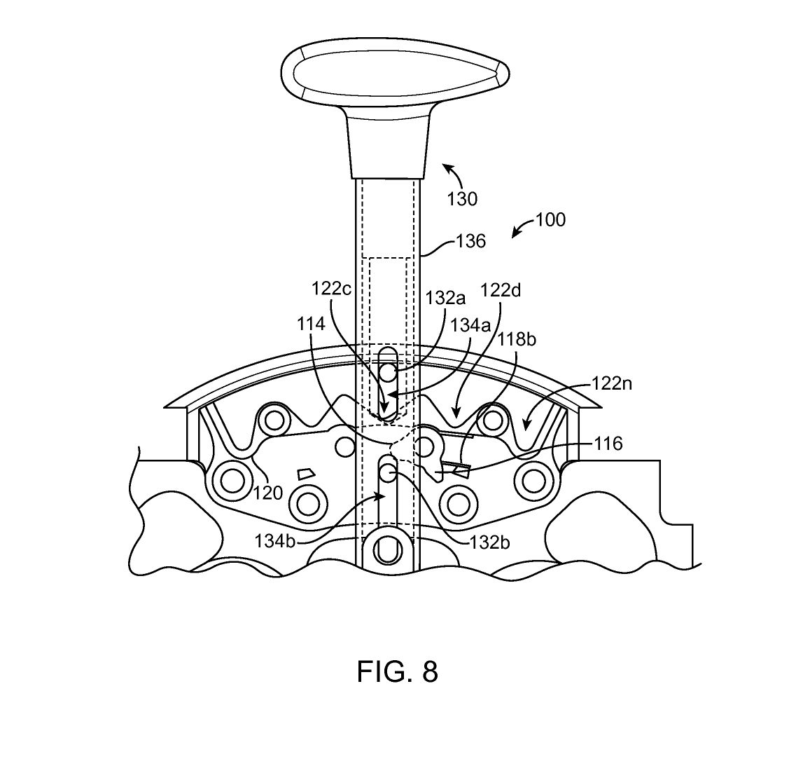

FIG. 8 illustrates the lever 130 after the cross-pin 132b has cleared past the rotatable gate 110. At that position of the lever 130, the cross-pin 132a is positioned above the depression 122c, and is therefore not hindered/inhibited by any blocking structures. Similarly, the movement of the cross-pin 132b is not hindered by any blocking structure (movement control structure), and, therefore, the lever 130 may continue to be moved in a directions along the length of the frame 120. If desired, the cross-pins 132a and 132b may be lowered, to thus place the cross-pin 132a in the depression 122c. This may be done, for example, if the present position of the lever 130 (as depicted in FIG. 8) is the desired position for the lever 130. By lowering the cross-pins, the cross-pin 132a will be prevented from moving in the direction along the length of the frame 120, and, therefore, the lever 130 will be effectively locked into its current position until the cross-pins are actuated so as to lift them and thus release the lever 130 and enable the lever to be moved to another position in the frame 120.

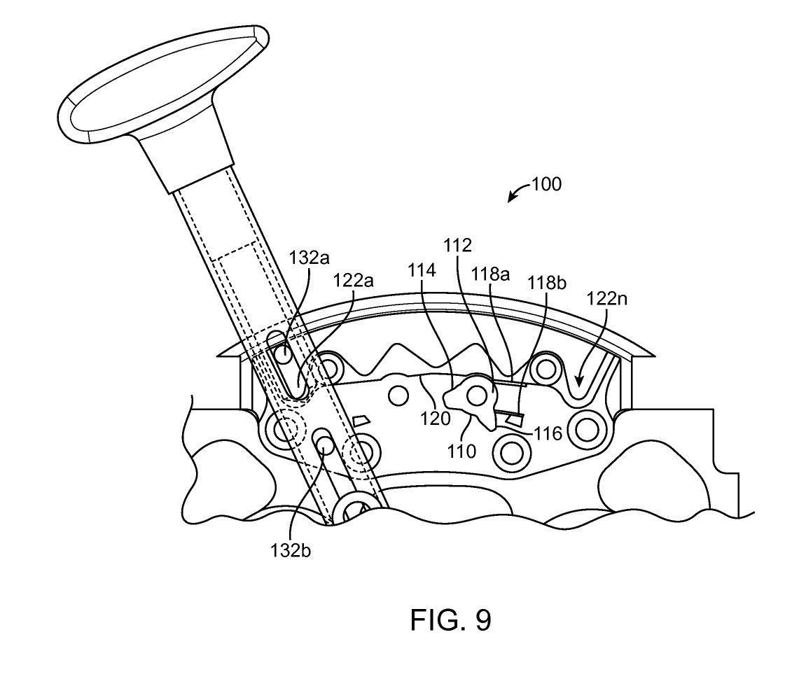

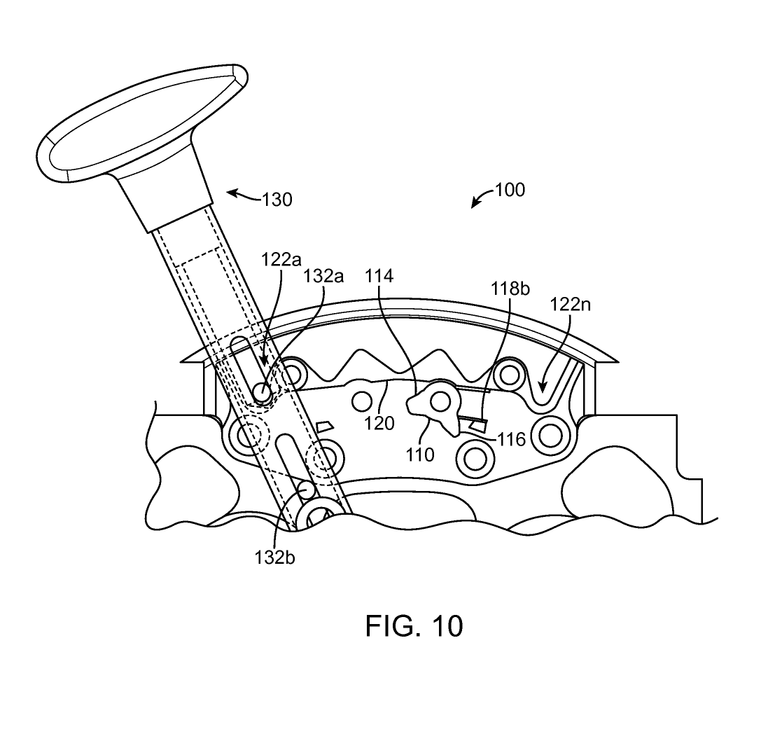

FIGS. 9 and 10 show the lever 130 moved to a position above the depression 122a (in FIG. 9), and in a position where the cross-pin 132a has been lowered into the depression 122a (in FIG. 10) to thus restrict further movement of the lever 130 (effectively locking it into place).

As noted, in some implementations, additional movement control structures, such structures similar to the rotatable gate 110, may be used and placed in such positions relative to the frame 120 of the assembly 100 where it may be desired, for example, to prevent accidental errant movement of the lever 130 into a particular position. For example, is some implementations, it may be required that before the lever is moved to a position where it is placed in the depression 122b, the lever should first be required to be placed in the depression 122c. Under such circumstances, to implement such a movement sequence one or more additional rotatable gates, such as the gate 110, may be included in the assembly in a position that is approximately under the depression 122c. Furthermore, such additional gates could be positioned above the depressions defined in the frame 120 and/or below the depressions (as done in relation to the rotatable gate 110). Using such rotatable gates would enable preventing the cross-pins 132a and/or 132b from moving past such rotatable gates without first lowering the cross-pins into them. Thus, as noted, the use of rotatable gates, such as the gate 110, enables implementation of a pre-determined (e.g., programmable) sequence of movement operations, that in turn provides better control of movement undertaken by a moveable mechanical structure (such as the lever 130) to prevent errant operations.

In some implementation, when the lever 130 (or some other moveable mechanical structure) moves in the opposite direction (i.e., in a direction towards the depression 122n) and reaches the rotatable gate 110, the cross-pin 132b will generally slide under the appendage 114, and will push the appendage 116 so as to cause the gate 110 to rotate in a counter-clockwise direction. The cross-pin 132b will be able to pass through the space opened between the appendage 116 and the protrusion 142 as a result of the counter-clockwise movement of the appendage 116 (and of the gate 110). Thus, in some implementation, the rotatable gate 110 can be configured to restrict movement of the lever 130 (or of some other moveable structure) in only one direction. That is, the gate 110 may be configured to require that the lever follow a pre-determined sequence of operations in order to move past the gate 110 in that particular direction, but to not require that any special sequence of operations be followed in order to move the lever 130 past the gate 110 in the opposite direction. In some embodiments, a rotatable gate may be configured to restrict movement of a lever, or some other moveable structure, in two directions (e.g., clockwise and counter-clockwise).

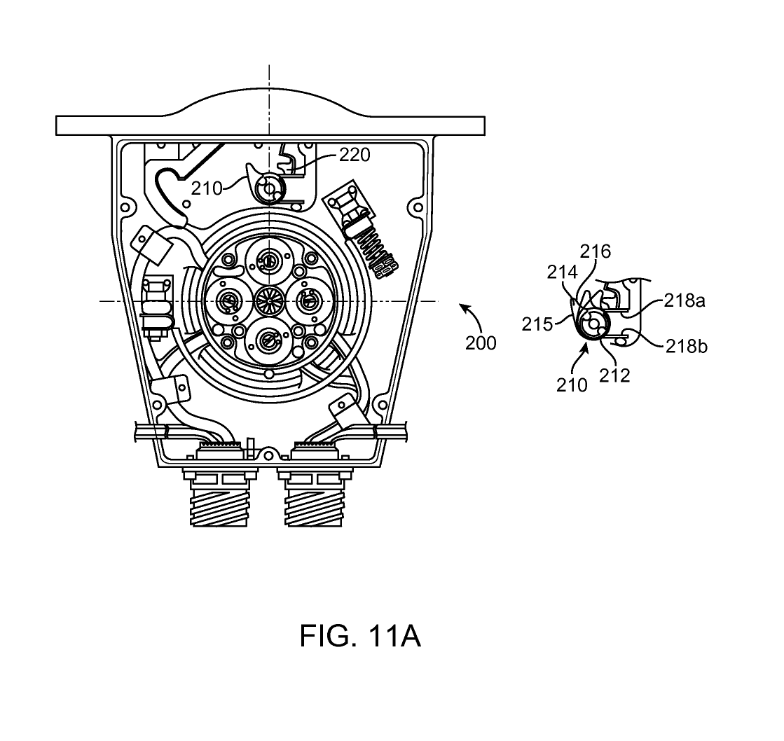

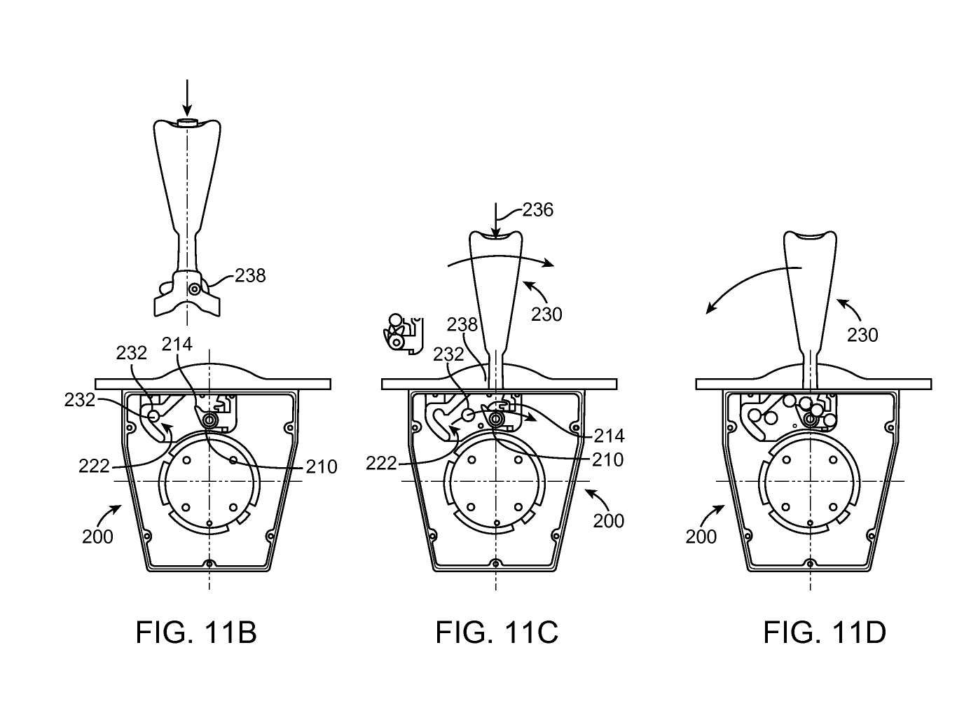

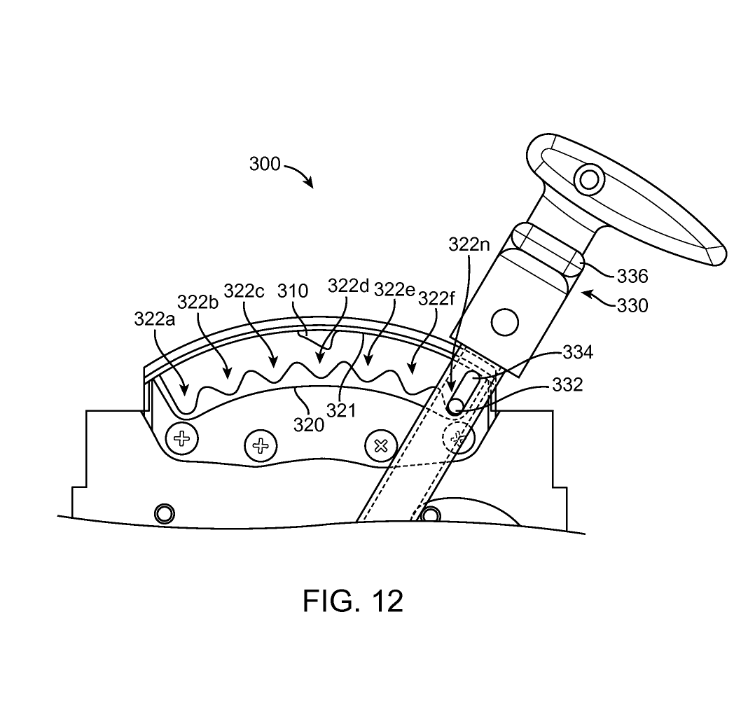

In some implementations, other types of gates to control the movement of moveable mechanical structures, such as levers, may be used. For example, in some embodiments, assemblies may be implemented that include a rotatable gate similar to the rotatable gate 110 of FIGS. 1-10 (i.e., a rotatable gate with two or more appendage), a rotatable gate with a single appendage (as more particularly described below in relation to FIGS. 11A-D), a fixed gate, such as the depression-shaped gates 122a-n depicted in FIGS. 1-10, and/or a fixed “bulk-head” gate similar to the bulk gate 310 that will be described below in relation to FIGS. 12-19. In some embodiments, assemblies may be provided that include at least one rotatable gate (e.g., a rotatable gate with a single appendage or with two appendages), and at least one fixed gate (e.g., a bulk-head gate) that define a pre-determined path or sequence of operations through which a moveable structure has to undergo in order to be displaced. Thus, an assembly with a combination of one or more rotatable gates and one or more fixed gates may be used to control movement of the moveable mechanical structure to, for example, prevent unintended displacement of the mechanical structure into positions in the assembly that would result in causing impermissible or dangerous actions taking place (e.g., to prevent, in circumstances where the moveable mechanical structure is part of an aircraft's controls, impermissible deployment or retraction of flaps, an impermissible deployment of the landing gear, etc.)

Thus, with reference to FIG. 11A, a side-view diagram of an assembly 200 that includes a rotatable gate 210 with one appendage is shown. Similarly to the rotatable gate 110 of FIG. 1, the rotatable gate 210 may include, in some implementations, a rotatable body, such as a disc 212, and at least one projection 214, also referred to as an appendage, extending from the rotatable body. The appendage 214 is configured to be actuated by a moveable mechanical structure (not shown in FIG. 11A) when the moveable mechanical structure contacts the side surface 215 of the appendage 214. When the mechanical structure contacts the appendage 214, it pushes the appendage, thus actuating the gate 210 to cause its rotation. In the example of FIG. 11A, contact by the mechanical structure (lever) causes rotation of the gate 210 in a clockwise direction. The appendage 214 is further configured to stop rotational movement of the gate 210 in a first direction, for example, in a clockwise direction, beyond a first angular position of the rotatable body when another side surface 216 of the appendage 214 contacts a blocking structure, such as a protrusion 220.

The gate 210 may also include one or more resilient members, such as springs 218a and 218b, which are biased in such a way to cause the rotatable body of the gate 210 to return to a resting angular position when the gate 210 is not actuated. For example, the spring 218b may be coupled to a frame and to the rotatable gate 210. When the rotatable gate 210 is actuated and is rotated clockwise, the spring 218b is stretched. When the rotatable gate 210 is released, the stretched spring 218b can exert torque in a generally counter-clockwise direction, and will thus cause the rotatable gate to rotate in a general counter-clockwise direction towards the rotatable gate's initial rest position.

FIGS. 11B-D are side-view diagrams of the interior of the assembly 200, showing the rotatable gate 210 in operation in the assembly 200. Initially, as shown in FIG. 11B, a cross-pin 232 of a lever 230 that is held in place in a depression 222 defined in a frame 220. While FIGS. 11B-D show a single depression 222 (which may correspond, for example, to a Stow position), additional depressions for holding the cross-pin 232 may be defined. To move the lever to another position, the cross-pin is actuated to cause it to be released from the depression. For example, a button 236 on the lever actuates the cross-pin to cause the cross-pin 232 to be pushed down and out of the depression 222, to thus enable the lever (e.g., the bottom part 238 of the lever 230) to be moved within an inner space inside the assembly 200.

With reference to FIG. 11C, as the lever 230 is actuated and is displaced the cross-pin 232 will reach the gate 210 and will come in contact with a first side of the appendage 214. The cross-pin 232, moving with the lever 230, will therefore actuate the appendage 214 and will cause the appendage 214 to, in the example embodiments of FIGS. 11B-D, to rotate in a clockwise direction until the appendage 214 hits the protrusion 220 (i.e., the second side 216 of the appendage opposite the side of the appendage actuated by the cross-pin). Once the appendage 214 hits the protrusion, the rotational movement of the gate is stopped, and as a result, the cross-pin pushing against the appendage will be prevented/inhibited from continuing to move. Thus, to enable the lever to continue moving, the cross-pin is releases, e.g., by releasing the button 236, which causes the cross-pin 232, in the example embodiments of FIGS. 11B-D, to be elevated slightly.

Once the released cross-pin 232 is sufficiently lifted/elevated so that it breaks contact with the appendage 214 of the gate 210, the gate 210 will be rotated in a counter-clockwise direction as a result of, for example, the forces exerted by the springs 218a and/or 218b, towards the gate's resting angular position. Subsequent to the counter-clockwise rotation of the gate 210, the cross-pin 232 can now pass through the space defined between the appendage (after sufficient counter-clockwise rotation by the appendage 214) and the protrusion 220, enabling the cross-pin 232, and thus the lever 230, to continue moving towards other positions in the assembly 200.

FIG. 11D shows a path followed by the cross-pin 232 as it moves back to a locking position within the depression 222. As shown, when moving in a direction opposite that depicted in FIG. 11C, the cross-pin 232 pushes against the second side of the appendage 214 (i.e., the side that hit the protrusion 220 when the cross-pin was being moved from the depression 222 towards other positions in the assembly 200), and causes the gate to rotate in a counter-clockwise direction. The cross-pin 232 can slide along the appendage as it is pushing against it until the cross-pin 232 clears the distal tip of the appendage 214. Once it clears the appendage 214, the cross-pin 232 can continue moving towards the depression 222, while the gate rotates in a clock-wise direction to its resting position.

As noted another type of gate to control the movement of moveable mechanical structures is a fixed “bulk-head” gate. With reference to FIG. 12, a side view diagram of example embodiments of an interior of an assembly 300 that includes a bulk gate (also referred to as a block protrusion) 310 is shown. As noted, bulk gates, which are fixed gates, may be positioned within assemblies that include a moveable mechanical structure (such as a lever) to define a pre-determined path and/or a pre-determined sequence of actuation operations that the mechanical structure would have to follow in order to move from one position to another so as to reduce the likelihood of dangerous errant moves of the mechanical structure. The bulk protrusion 310 may extend from an elevated supporting structure such as a top wall 321 of a frame 320.

Thus, in some embodiments, the assembly 300 may include the frame (archway) 320 that defines multiple depressions 322a-n. Each of the depressions 322a-n defines a fixed (stationary) gate corresponding to a position (associated with an action) for a moveable mechanical structure 330. As with the assembly 100 depicted in FIGS. 1 and 3-10, the depressions 322a-n are configured to prevent movement of the moveable mechanical structure 330 when a cross-pin 332 extending transversely from the moveable mechanical structure is lowered into the depression. In some embodiments, the assembly 300 may include two mirror frames such as the frame 320, each defining multiple depressions, such that one end of the cross-pin 332, when positioned near the bottom of a slot 334, rests in one of the depressions 322a-n, while another end of the cross-pin 332 rests in a counterpart depression defined in the mirror frame. The moveable mechanical structure can move (e.g., pivot) in a space defined between the two mirror frames (the assemblies 100 and 200 of FIGS. 1 and 2, respectively, may likewise have similar mirror frame arrangements).

In the example embodiments of FIG. 12, actuation of the cross-pin 332 may be implemented using a spring loaded trigger mechanism that includes a trigger handle 336 coupled to the cross-pin using, for example, a cord, and a spring coupling the cross-pin to the lever (e.g., to a location near the bottom of the slot 334 through which the cross-pin 332 can move). To lift the cross-pin 332, the trigger handle 336 may be raised, thus pulling the cross-pin. As a result of the lifting of the cross-pin 332, the spring coupling the cross-pin 332 to the lever 330 is extended, causing a force to be exerted in a direction opposite the direction of spring extension. When the trigger is released, the extended spring causes the cross-pin to return to its resting position at around the bottom of the slot 334.

Operation of the assembly 300, including of the bulk gate 310 and of the multiple fixed gates 322a-n defined in the frame 320 is shown with reference to FIGS. 12-19. In FIG. 12, the moveable mechanical structure is in a position in which the cross-pin 332 is positioned near the bottom end of the slot 334 and is resting within depression 322n. In the example embodiments of FIG. 12, the depression 322n in which the cross-pin 332 is resting may correspond to a position in which flaps and/or slats of an aircraft are fully deployed.

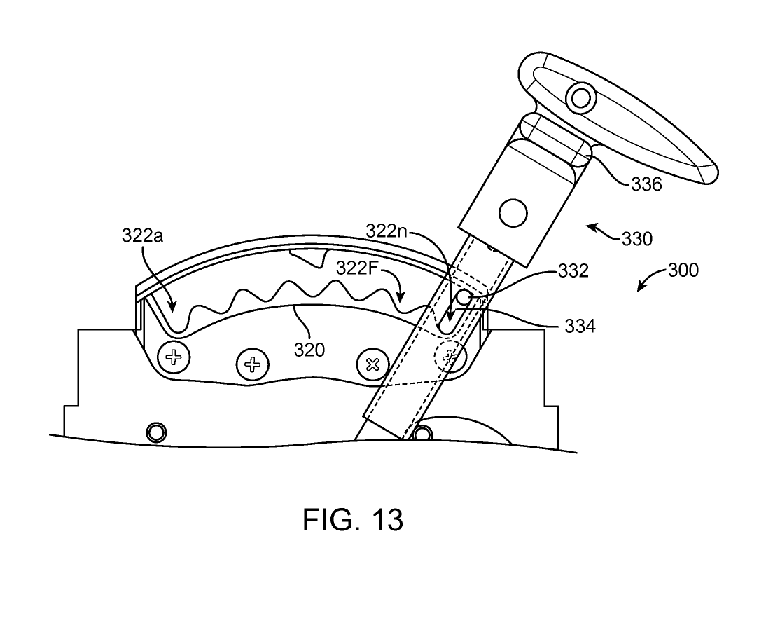

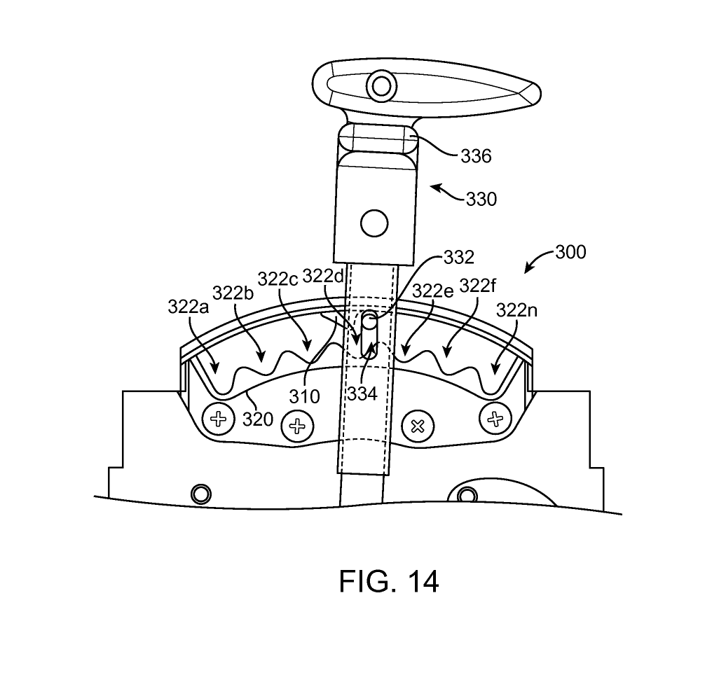

Suppose it is now desired to retract the flaps/slats by moving the lever 330 from its full flaps/slats deployment position in depression 322n to the flaps/slats retracted position (which may correspond to the depression 322a). Accordingly, as shown in FIG. 13, to shift the lever to another position, the cross-pin 332 is first lifted by, for example, actuating the trigger (e.g., lifting the trigger handle 336) to raise the cross-pin 332 so that it clears the depression 322n. As shown in FIG. 14, while the trigger continues to be actuated, the lever 330 may be shifted along an arched path traversing the length of the frame 320. Because there are no blocking gates to hinder (and thus control) the movement of the lever 330 between the depression 322n and the depression 322d, the lever 330 may be shifted in a continuous unbroken motion until it reaches the bulk gate 310. Once at least one of the ends of the cross-pin 332 reaches and contacts the bulk gate 310, the gate 310 blocks the end of the cross-pin and thus prevents the lever 330 from continuing its movement towards the desired destination position. As noted, in some embodiments, the other end of the cross-pin 332 may reach and contact a mirror bulk gate in a mirror frame of the frame 320.

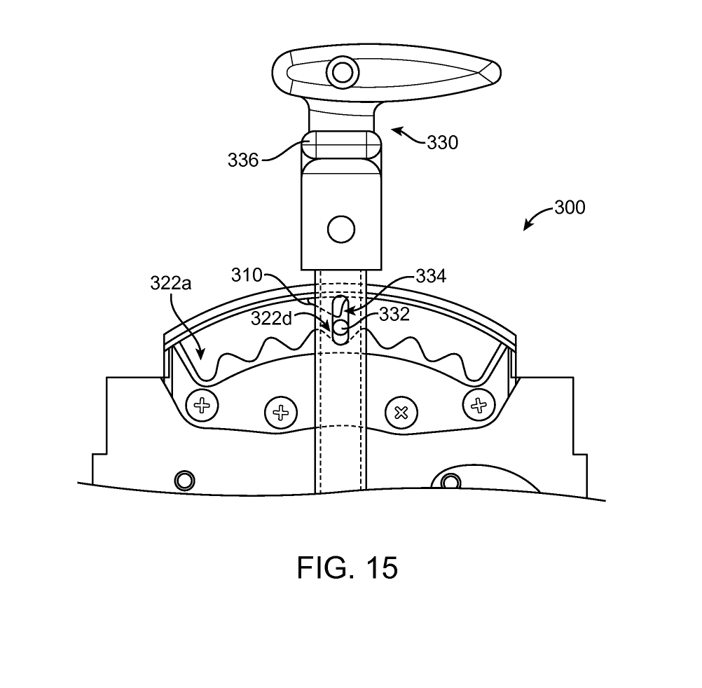

To enable the lever 330 to move past the bulk gate 310, the cross-pin 332 is released so that the cross-pin's vertical position is lowered below the bulk gate 310, as more particularly shown in FIG. 15. When released (e.g., by releasing the trigger), the cross-pin 332 may be lowered into the depression 322d (although in some embodiments, the cross-pin 332 may only partially have to be released so it falls below the bulk gate 310, but without coming to rest at the bottom of the depression 322d). Thus, use of a bulk gate enables the addition of a cross-pin lowering operation into the lever movement manipulation mechanism to prevent, for example, errant movements of the lever into positions the user did not intend to move the lever into. For example, it may be a requirement of the lever manipulation mechanism that the user carefully consider if the lever should be shifted into a position corresponding to the depression 322c. To prevent the user from an inadvertent movement of the lever 330 into the depression 322c from position corresponding to the depressions 322d-n, the bulk gate 310 effectively forces the user to stop the continuous motion of moving the lever once the lever reaches the bulk gate 310, and forces the user to consciously lower the cross-pin 332 into the depression 322d. If the user intended to move the lever to the depression 322c, the user would have to raise the cross-pin again, shift the lever, and release the cross-pin into the depression 322c. Therefore, moving the lever 330 from one of the depressions 322d-n into the depression 322c requires the user to perform, in this example, six (6) lever manipulation operations when the bulk gate 310 is employed. On the other hand, if the bulk gate 310 was not used, three (3) operations would be required to shift the lever into the depression 322c (namely, lift the cross-pin, shift the lever so that the cross-pin is above the depression 322c, and release the cross-pin), thus increasing the likelihood of an inadvertent shift of the lever 330 into the depression 322c when that was not the intended destination position for the lever.

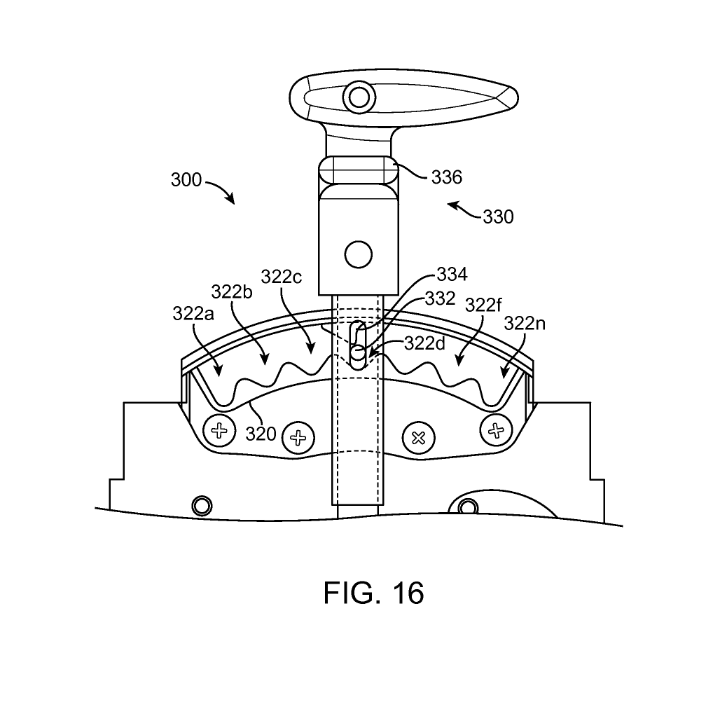

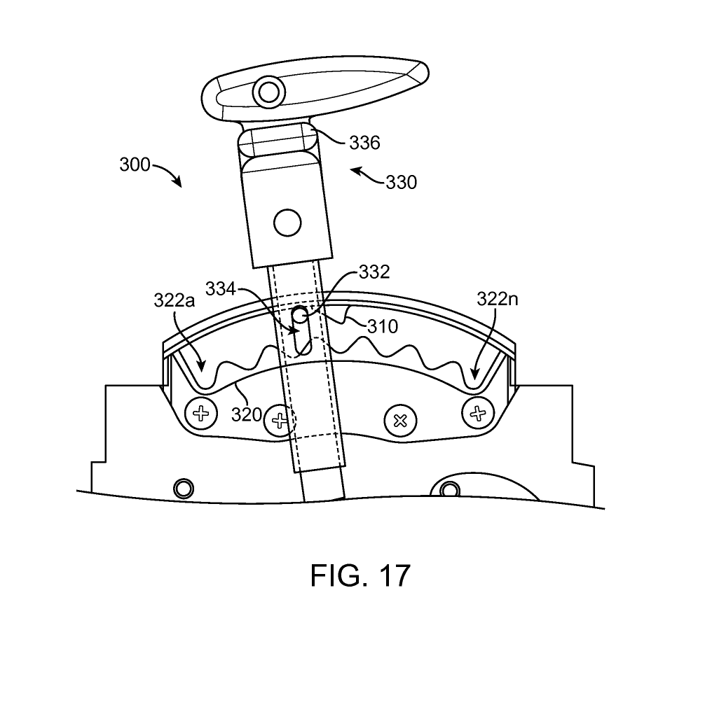

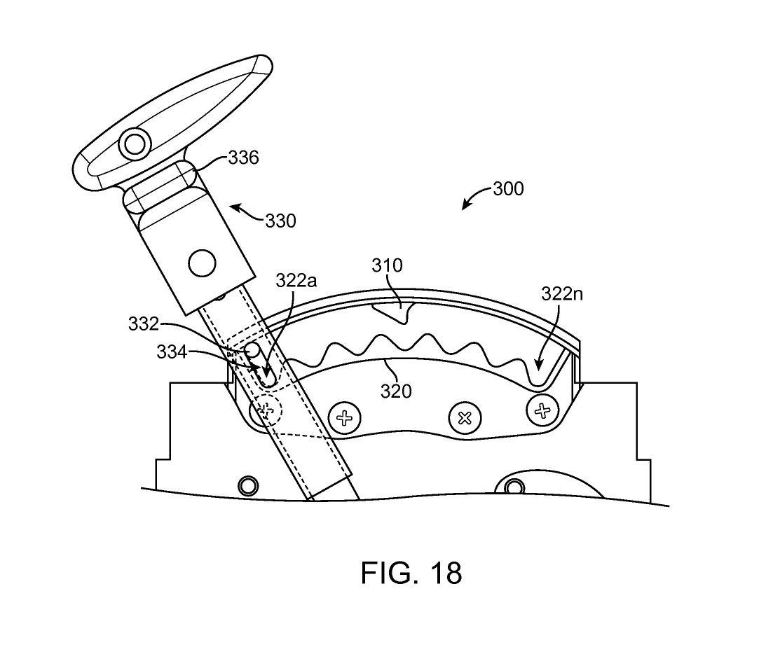

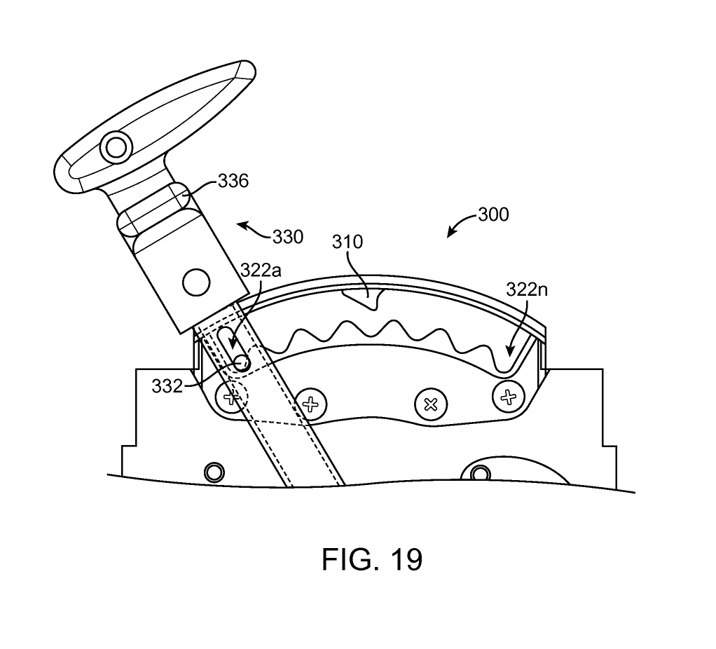

If the lever is to be shifted to one of the depressions 322a-c, then, as shown in FIG. 16, the lever trigger 336 is actuated (e.g., trigger is raised) to cause the cross-pin to be lifted from the depression 322d into which it had to be lowered once the lever reached the position where the cross-pin came in contact with the bulk gate 310. With the cross-pin 332 now lifted towards the top end of the slot 334, the lever is once again free to be shifted towards the depression 322a. Although the bottom tip of the bulk gate 310 may, in some embodiments, hinder full lifting of the cross-pin, the cross-pin 332 is sufficiently lifted so that the lever 330 can be shifted in a direction towards depressions 322a-c. As shown in FIG. 17, as the lever 330 continues to be moved along the length the frame 320, the cross-pin 332 is no longer hindered/inhibited by any part of the bulk gate 310. In FIG. 18 the lever 330 is shown to have reached the far end of the inside of the assembly 300 where the cross-pin is positioned right above the depression 322a, and in FIG. 19 the cross-pin 330 is lowered into the depression 322a (e.g., by releasing the trigger 336) to lock the lever into that position (which may correspond to the stow position).

In some implementations, a combination of rotatable (slidable) gates and fixed gates may be employed to realize a pre-determined path and/or a pre-determined sequence of operations that a moveable mechanical structure would need to undergo in order to control the movement of that mechanical structure. Thus, in some embodiments, an assembly is provided that includes a moveable mechanical structure (such as, for example, a lever used to manipulate a system, like flaps, engine thrust, breaks, etc.) and one or more rotatable gates to control movement of the moveable mechanical structure. Each of the one or more rotatable gates gate may include, in some implementations, a rotatable body (e.g., a disc), and an appendage extending from the rotatable body, the appendage configured to contact the moveable mechanical structure that, when the moveable mechanical structure contacts the appendage, actuates the gate to cause rotation of the gate. The assembly may further include one or more stationary gates, with each of the one or more stationary gates including one or more of, for example, a member defining a depression, the member configured to prevent movement of the moveable mechanical structure when a cross-pin extending transversely from the moveable mechanical structure is lowered into the depression, and/or a bulk protrusion extending from an elevated supporting structure, the bulk protrusion configured to prevent movement of the moveable mechanical structure when the cross-pin contacts the bulk protrusion.

Although particular embodiments have been disclosed herein in detail, this has been done by way of example for purposes of illustration only, and is not intended to be limiting with respect to the scope of the appended claims, which follow. In particular, it is contemplated that various substitutions, alterations, and modifications may be made without departing from the spirit and scope of the invention as defined by the claims. Other aspects, advantages, and modifications are considered to be within the scope of the following claims. The claims presented are representative of the embodiments and features disclosed herein. Other unclaimed embodiments and features are also contemplated. Accordingly, other embodiments are within the scope of the following claims.

What is claimed is:

1. A gate to control movement of mechanical structures, the gate comprising:
a rotatable body; and
at least two appendages extending from the rotatable body, including a first appendage configured to stop rotational movement of the gate in a first direction beyond a first angular position when the first appendage contacts a blocking structure, and a second appendage configured to contact a moveable mechanical structure external to the gate that, when the moveable mechanical structure contacts the second appendage, actuates the gate to cause rotation of the gate.

2. The gate of claim 1, further comprising:
one or more springs configured to stop rotational movement of the gate in a second direction beyond a second angular position when the one or more springs contact at least one blocking structure, the one or more springs being biased to cause the rotatable body to return to a resting angular position when the gate is not actuated.

3. The gate of claim 1, wherein the rotatable body includes a disc.

4. An assembly comprising:
a moveable mechanical structure; and
a gate to control movement of the moveable mechanical structure, the gate comprising:
a rotatable body; and
at least two appendages extending from the rotatable body, including a first appendage configured to stop rotational movement of the gate in a first direction beyond a first angular position when the first appendage contacts a blocking structure, and a second appendage configured to contact the moveable mechanical structure that, when the moveable mechanical structure contacts the second appendage, actuates the gate to cause rotation of the gate.

5. The assembly of claim 4, wherein the gate further comprises:
one or more springs configured to stop rotational movement of the gate in a second direction beyond a second angular position when the one or more springs contact at least one blocking structure, the one or more springs biased to cause the rotatable body to return to a resting angular position when the gate is not actuated.

6. The assembly of claim 4, wherein the moveable mechanical structure includes:
a lever configured to be moved along a pre-determined path.

7. The assembly of claim 6, wherein the lever is a lever to control flap extension in an aircraft.

8. The assembly of claim 6, wherein the blocking structure includes:
an archway including a slot defining the pre-determined path in which the lever is configured to be moved.

9. The assembly of claim 4, further comprising:
one or more stationary gates, each of the one or more stationary gates comprising at least one of:
a member defining a depression, the member configured to prevent movement of the moveable mechanical structure when a cross-pin extending transversely from the moveable mechanical structure is lowered into the depression, or
a bulk protrusion extending from an elevated supporting structure, the bulk protrusion configured to prevent movement of the moveable mechanical structure when the cross-pin contacts the bulk protrusion.

10. The assembly of claim 9, wherein the moveable mechanical structure further includes another cross-pin extending transversely from the moveable mechanical structure, the other cross-pin configured to actuate the second appendage of the rotatable gate when the other cross-pin contacts the rotatable gate.

11. The assembly of claim 4, wherein the rotatable body includes a disc.

12. The assembly of claim 4, further comprising one or more additional gates to control movement of the moveable mechanical structure, each of the one or more additional gates comprising:
a corresponding rotatable body; and
corresponding at least two appendages extending from the corresponding rotatable body, including a corresponding first appendage configured to stop rotational movement of the corresponding each of the one or more additional gates in a corresponding first direction beyond a corresponding first angular position when the first corresponding appendage contacts a corresponding blocking structure, and a corresponding second appendage configured to contact the moveable mechanical structure that, when the moveable mechanical structure contacts the corresponding second appendage, actuates the corresponding each of the one or more additional gates to cause rotation of the corresponding each of the one or more additional gates.

13. The assembly of claim 4, wherein the rotatable gate defines a pre-determined sequence of actuation operations required to be applied to the moveable mechanical structure to move the mechanical structure from a first position to a second position.

14. The assembly of claim 13, wherein the pre-determined sequence of operations includes one or more of: an operation to push the moveable mechanical structure, an operation to pull a cross-pin of the moveable mechanical structure, or an operation to release the cross-pin of the moveable mechanical structure.

15. An assembly comprising:
a moveable mechanical structure;
one or more rotatable gates to control movement of the moveable mechanical structure, each of the one or more rotatable gates comprising:
a rotatable body, and
an appendage extending from the rotatable body, the appendage configured to contact the moveable mechanical structure that, when the moveable mechanical structure contacts the appendage, actuates the gate to cause rotation of the gate; and
one or more stationary gates, each of the one or more stationary gates including one or more of:
a member defining a depression, the member configured to prevent movement of the moveable mechanical structure when a cross-pin extending transversely from the moveable mechanical structure is lowered into the depression, or
a bulk protrusion extending from an elevated supporting structure, the bulk protrusion configured to prevent movement of the moveable mechanical structure when the cross-pin contacts the bulk protrusion.

16. The assembly of claim 15, wherein the moveable mechanical structure includes:
a lever configured to be moved along a pre-determined path.

17. The assembly of claim 16, wherein the lever is a lever to control flap extension in an aircraft.

18. The assembly of claim 15, further comprising:
one or more springs coupled to the rotatable body of at least one of one or more rotatable gates, the one or more springs biased to cause the rotatable body of the at least one of the one or more rotatable gates to return to a resting angular position when the at least one of the one or more rotatable gates is not actuated.

19. The assembly of claim 15, wherein the rotatable body includes a disc.

20. The assembly of claim 15, wherein the one or more rotatable gates and the one or more stationary gates define a pre-determined sequence of actuation operations required to be applied to the moveable mechanical structure to move the mechanical structure from a first position to a second position.
